(19) United States
(12) Patent Application Publication
(10) Pub. No.: US 2024/0327558 A1
(43) Pub. Date: Oct. 3, 2024

(54) Natural Binders for High-Strength Non-woven and Textile Fabrics

(71) Applicant: Board of Trustees of Western Michigan University, Kalamazoo, MI (US)

(72) Inventor: Abdus Salam, Kalamazoo, MI (US)

(21) Appl. No.: 18/594,736

(22) Filed: Mar. 4, 2024

Related U.S. Application Data
(60) Provisional application No. 63/450,445, filed on Mar. 7, 2023.

(51) Int. Cl. C08F 251/02; D04H 1/4382; D04H 1/587; D04H 1/645

(52) U.S. Cl. CPC C08F 251/02; D04H 1/43835; D04H 1/587; D04H 1/645; D10B 2401/063

(57) ABSTRACT

Embodiments of the present invention include a grafted aqueous carboxymethyl cellulose (CMC) binder comprising CMC chemically bonded with a monomer, where the CMC has a weight ratio of water to CMC of from about 99.9:0.1 to about 1,000:500, wherein the monomer is characterized by a weight ratio of monomer to CMC of from about 1:1 to about 1:1,000, and non-woven fabrics and articles including CMC binders, and methods of manufacture of the same. Aspects of the invention include a method of synthesizing a grafted aqueous carboxymethyl cellulose (CMC), the method comprising: contacting CMC with water to form a CMC solution. contacting the CMC solution with an initiator; contacting the CMC solution with a monomer to start grafting polymerization reaction between the CMC and a monomer. In some embodiments, the binder and non-woven fabrics including the same are non-toxic and biodegradable.

### CROSS REFERENCE TO RELATED APPLICATIONS

This application claims the benefit of U.S. Provisional Application 63/450,445, filed Mar. 7, 2023, the contents of which are incorporated herein by reference in their entirety.

### TECHNICAL FIELD

The present disclosure relates to natural binders for nonwoven fabric and textiles and synthesis of the same, and more specifically, the method of synthesizing grafted carboxymethyl cellulose and/or salts of carboxymethyl cellulose-based binders as well as methods of applying the same to nonwoven and textile fabrics, and articles using such fabrics.

### BACKGROUND OF THE INVENTION

Non-woven fabrics are generally used in applications such as wipes, moisturized wipes, flushable wipes, disposable wipes, tissues, towels, moisturized tissue towels (MTT), double re-creped (DRC) items, seed germination blankets, agricultural wraps, agricultural blankets, medical drapes, bandages, caps, face masks, surgical scrubs, medical gowns, filters, diapers, padding, packaging, insulation, carpeting, upholstery, fabric dryer sheets, and other disposable textiles.

Typically, air-laid-based non-woven fabrics are produced from pulp and/or plastic fibers, with strength added to the fabric base layer via treatment with a latex binder or further addition of pulp fiber plus the latex binder. In other applications, plastic (e.g., molten plastic or plastic fiber) may be added as well. Plastic and latex binders both add strength to the non-woven fabric web through melt bonding and chemical bonding between pulp fibers. Chemical bonding in non-woven fabric manufacture normally refers to the use of latex binders.

Latex binders have been in existence at least as long as most modern non-woven fabrics themselves. The great benefit of latex binders is their overall versatility and utility. However, the problem with their use is that they are expensive, non-biodegradable, as well as potentially toxic due to containing a high component of volatile monomers and free formaldehyde, which can cause issues during manufacture as well as subsequent emissions. These rising health and environmental concerns have caused latex binder-based non-woven fabrics to be banned in Europe beginning in 2023 as well as have the potential for their use to be limited in other countries as well.

To solve the problems inherent in latex binder-based non-woven fabrics, we have developed a novel grafted carboxymethyl cellulose and/or salts of carboxymethyl cellulose-based natural binder that is less expensive, nontoxic, and biodegradable. For ease of reference, carboxymethyl cellulose and/or salts of carboxymethyl cellulose are abbreviated as “CMC” throughout, unless specifically noted.

CMC has been applied to non-woven fabrics and has been used in some applications: e.g., US20200085700A1, where CMC is used in the presence of a non-polar solvent; and US20210054548A1, where CMC is used as a natural binder to add some strength to non-woven fabric but also facilitates rapid dispersion under wet conditions, such that they are e.g., flushable. More wet strength was provided in US 20190226150A1 by Organo Click AB, but the CMC process described therein conveys a lower wet strength due to ionic bonding of agents with CMC and may show undesired yellowing of the material under certain conditions.

The grafted CMC-based natural binder and blends thereof of the present invention can be used in many applications as an alternative to petroleum-based latex binders like EVA, acrylic, styrene etc. for nonwoven fabrics and textiles. A key feature of the biodegradable fabrics of the present disclosure is such fabrics' wet strength, i.e., the amount of resistance to tearing, decomposition or other damage under wet conditions such as short or long-term exposure to water and other liquids. The relatively low (i.e., almost no) wet strength of some bio-based biodegradable non-woven fabric binders in the prior art may be a feature for some uses: for instance, some seed germination fabrics may slowly decompose when wet to aid seedlings to grow out of the material, and single-use wipes may disintegrate when flushed down the toilet. However, this can be an undesired problem for many areas in which non-woven fabrics are used, such as, for example ‘wet wipes’ stored in an aqueous solution prior to use, which also may contain other aqueous and non-aqueous agents such as, e.g., bleach, sanitizer, lotions and perfumes.

A desirable binder for non-woven fabrics is thus one that may use non-toxic materials in preparation, may be biodegradable, and may have a high permanent wet strength that can be adjusted for various applications.

### SUMMARY OF THE INVENTION

Embodiments of the present invention may include a grafted aqueous carboxymethyl cellulose (CMC) binder comprising CMC chemically bonded with a monomer, where the CMC is characterized by a weight ratio of water to CMC of from about 99.9:0.1 to about 1,000:500, wherein the monomer is characterized by a weight ratio of monomer to CMC of from about 1:1 to about 1:1,000. In further embodiments, the monomer includes n-hydroxy methyl acrylamide. In other embodiments, the CMC includes a CMC salt, a CMC alkali salt, or a CMC-Na salt. In some embodiments, the binder is a sprayable aqueous solution. In yet other embodiments, the binder includes CMC in an amount of from about 0.1 wt. % to about 70 wt. % of the total weight of the binder. In others, said binder includes the monomer in an amount of from about 0.1 wt. % to about 90 wt. %.

In other embodiments, the binder further includes an initiator in an amount of from about 0.1 wt. % to about 10 wt. % of the total weight of the binder. In some embodiments, the initiator includes K₂S₂O₈ and/or K₂S₂O₈ with H₂O₂. In others, the binder is formed via a graft polymerization reaction between CMC-Na and N-hydroxymethyl acrylamide, wherein the graft polymerization reaction temperature occurs from about 10° C. to about 200° C., where the reaction is run from about 0.01 minutes to about 5,000 minutes.

In others, the binder further comprises polymer n-hydroxymethyl acrylamide, wherein said polymer n-hydroxymethyl acrylamide is not chemically bound to said CMC bonded with a monomer.

In other embodiments, the binder is biodegradable.

Aspects of the present invention may include a method of synthesizing a grafted aqueous carboxymethyl cellulose (CMC), the method comprising: contacting CMC with water to form a CMC solution; contacting the CMC solution with an initiator; contacting the initiator-treated CMC solution with a monomer to start grafting polymerization reaction between the CMC and a monomer; and maintaining said grafting polymerization reaction for about 0.1 to about 5,000 minutes at a reaction temperature of about 10° C. to about 200° C.

In other aspects, the CMC is a CMC salt, an alkali salt of CMC, and/or CMC-Na. In other aspects, the initiator comprises K₂S₂O₈ and/or K₂S₂O₈ with H₂O₂. In yet other aspects, the grafted aqueous CMC binder is characterized by a weight ratio of initiator to CMC of from about 1:1 to about 1:100. In still others, the monomer comprises n-hydroxymethyl acrylamide, and wherein the resulting aqueous grafted CMC is characterized by a weight ratio of monomer to CMC of from about 1:1 to about 1:1,000.

Other aspects of the present invention may include a method of making a nonwoven fabric, the method comprising: applying a portion of aqueous grafted CMC binder to a non-woven fabric base layer to form a binder-impregnated nonwoven fabric, wherein said aqueous grafted CMC binder comprises CMC chemically bonded with a monomer, wherein the CMC is characterized by a weight ratio of water to CMC of from about 99.9:0.1 to about 1,000:500, wherein the monomer is characterized by a weight ratio of monomer to CMC of from about 1:1 to about 1:1,000.

In other aspects, the dry weight ratio between grafted CMC-Na binder and pulp fiber web is about 1.2:10. In other aspects, applying a portion of aqueous grafted CMC binder to a non-woven fabric base layer further includes spraying said portion of aqueous grafted CMC binder onto said non-woven fabric base layer to form a binder-impregnated non-woven fabric. In other aspects, the method further includes curing said binder-impregnated nonwoven fabric, at 165° C. for 5 minutes.

Embodiments of the present invention may include a non-woven fabric, including a grafted aqueous carboxymethyl cellulose (CMC) binder comprising CMC chemically bonded with a monomer, wherein the CMC is characterized by a weight ratio of water to CMC of from about 99.9:0.1 to about 1,000:500, wherein the monomer is characterized by a weight ratio of monomer to CMC of from about 1:1 to about 1:1,000.

In other embodiments, the non-woven fabric comprises pulp fibers in an amount from 30 wt. % to about 99.9 wt. %, based on the total weight of the nonwoven fabric and CMC in an amount of from about 0.01 wt. % to about 30 wt. %, based on the total weight of the nonwoven fabric. In others, the nonwoven fabric is characterized by a dry tensile strength measured about 10.68 newtons. In yet others, the nonwoven fabric is characterized by a wet tensile strength measured about 4.91 newtons.

Embodiments of the present invention include an article comprising a non-woven fabric comprising a grafted aqueous carboxymethyl cellulose (CMC) binder comprising CMC chemically bonded with a monomer, wherein the CMC is characterized by a weight ratio of water to CMC of from about 99.9:0.1 to about 1,000:500, wherein the monomer is characterized by a weight ratio of monomer to CMC of from about 1:1 to about 1:1,000. In other embodiments, the article is a wipe, moisturized wipe, flushable wipe, tissue, towel, moisturized tissue towel, DRC item, seed blanket, agricultural wrap, agricultural blanket, medical drape, bandage, cap, face mask, surgical scrub, medical gown, filter, diaper, padding, packaging, insulation, carpeting, fabric dryer sheet, disposable textile.

Other features and advantages of the present invention will become apparent from the following detailed description, including the drawing. It should be understood, however, that the detailed description and the specific examples, while indicating preferred embodiments, are provided for illustration only, because various changes and modifications within the spirit and scope of the invention will become apparent to those skilled in the art from the detailed description.

### DESCRIPTION OF THE DRAWINGS

FIG. 1 is a graphical representation of an aspect of the grafting polymerization reaction scheme to produce embodiments of the present invention;

FIG. 2 shows the effect on wet tensile strength (in kgf) of embodiments of the grafted binder of the present invention prepared with varying concentrations of n-hydroxy methyl acrylamide monomer;

FIG. 3 shows the effect on wet tensile strength (in kgf) of embodiments of the grafted binder of the present invention prepared with varying concentrations of initiator (K₂S₂O₈);

FIG. 4 shows the effect on wet tensile strength (in kgf) of embodiments of the grafted binder of the present invention prepared under varying reaction times;

FIG. 5 shows the effect on wet tensile strength (in kgf) of embodiments of the grafted binder of the present invention prepared under varying reaction temperatures;

FIG. 6 is a table comparing the tensile strength of a latex binder of the prior art (V-192 from Wacker Chemical) and two embodiments of the present invention;

FIG. 7 depicts an experiment comparing the wet tensile strength over time (12 weeks) of an embodiment of the present invention to a latex binder of the prior art (dry wt. pulp fiber and natural binder ratio is 88:12), maintained at 40° C. to simulate rapid aging conditions, where both fabrics were lotion-treated;

FIG. 8 depicts an experiment testing the tensile wet strength over time (12 weeks) of an embodiment of the present invention to grafted CMC binder or latex binder of the prior art applied at a 6% rate (dry wt. pulp fiber, plastic fiber and natural binder ratio is 74:20:6), maintained at 40° C. to simulate rapid aging conditions, where both fabrics were lotion-treated.

### DESCRIPTION OF THE INVENTION

Definitions. The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an,” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims

Non-woven Fabrics. Nonwoven fabrics can be broadly defined as sheet or web structures bonded together by entangling fiber or filaments (and by perforating films) mechanically, thermally, or chemically. They are flat, porous sheets that are made directly from separate fibers or from molten plastic or plastic film. A nonwoven sheet may be material comprised of a sheet of fibers, continuous filaments (e.g., fiber precursors), or chopped yarns of any nature or origin, that have been formed into a web by any means, and bonded together by any means, with the exception of weaving or knitting. Some nonwoven fabrics have sufficient web strength after forming to be handled even if they are subsequently additionally bonded, for example when a bonding step is an integral part of the web-forming process, as in spun-bond and melt-blown nonwovens. Most other webs have relatively little strength as formed and may require an additional bonding step (e.g., chemical bonding) in order to make the nonwoven web suitable for its intended end use.

Cellulose and modified cellulose are common fiber sources for the base layer of non-woven fabrics, as they are relatively inexpensive, renewable, and in an untreated state, biodegradable materials. To an extent, the strength and other properties, such as softness and absorbency, for example, of the base layer can be adjusted by the length of the fibers used, the morphology of the fibers themselves (e.g. the extent to which fibers contain microfibrils, i.e., cellulose chains or bundles of chain perpendicular to the main chain/bundle of chains), the density of fibers, mixture with fibers from other sources, thickness of the sheet and other aspect of their construction, which are well-known in the art.

Latex Binders. To increase sheet dry and/or wet strength, latex binders are commonly used in the art, which can be applied to the base sheet in a variety of ways. Latex binder preparations usually consist of water, monomer(s), surfactant(s) such as persulfate salts, ammonium chloride, citric acid, sodium bisulfite, initiators, buffers and/or preservatives. Common latex binder monomers include vinyl acetate, ethylene, vinyl chloride, butadiene and acrylonitrile, alone or in combination, which impart the non-woven sheet various properties from strength, adhesion, flame retardance, softness, elasticity, stiffness, to chemical resistance. Off-gassing of formaldehyde during production and in the final product can be an issue with the usage of some monomers used to produce latex binders, and for this reason has caused the use of latex binders to receive more regulatory scrutiny in many countries.

Example 1. In one example of the prior art, ethylene is reacted with vinyl acetate to make a copolymer, to which n-hydroxymethyl acrylamide side chains are added (VAE/NMA latex binder). Under acid conditions, the VMA/NMA is crosslinked with the cellulose base layer to add wet strength to non-woven fabric.

Natural binder. Several bio-based polymers based on polysaccharides, polylactic acid (PLA) and others can provide natural alternatives to fossil-based/nonbiodegradable binders.

Cellulose is the most abundant naturally occurring polymer in nature and thus in itself is a potential low-cost and potentially biodegradable candidate as a binder. While it is ultimately biodegradable (such as by microorganisms producing cellulase enzymes) it is not readily dissolvable in a bulk state in water due to hydrogen bonding between adjacent chains, such that it cannot readily serve as the basis of a binder that could be applied to the base layer of nonwoven fabrics (which may be themselves composed of longer-chain and bundled cellulose structures).

Modified cellulose compounds, which add side groups to the cellulose chain backbone that are thought to sterically hinder hydrogen bonding between side chains, and allow solubility in water. Modified cellulose compounds also usually retain their biodegradability.

CMC is widely used in foods and consumer products as a non-toxic thickener. CMC properties may be varied depending on the degree of substitution of hydroxyl groups on cellulose by polar carboxymethyl groups during synthesis between cellulose and chloroacetic acid or sodium chloroacetate, which makes the cellulose soluble; as well as the underlying length of the cellulose chains being modified (which can affect overall viscosity); as well as the amount of salts present in the mixture, which can be varied by the amount of purification after the usual alkali-catalyzed reaction of cellulose with chloroacetic acid; as well as temperature and acidity when in aqueous solution.

Throughout the application, for ease of reference, carboxymethyl cellulose and/or salts of carboxymethyl cellulose is abbreviated as “CMC” throughout, unless specifically noted. Salts of carboxymethyl cellulose may include any suitable alkaline metal salt, such as CMC-Na or CMC-K, CMC-Ca, CMC-Mg, and other suitable salts known in the art, of various suitable purities, backbone structures, sizes and final viscosities, unless otherwise specifically specified.

In embodiments of the present invention, various types of CMC and/or CMC-Na and/or alkaline metal or other salts of CMC may be used. For example, low, medium and high viscosity and/or molecular weight type carboxymethyl cellulose and/or carboxymethyl cellulose-sodium can be used as raw material in the synthesis of natural binder. In some aspects, the CMC is dissolved into water to prepare CMC solution. In one example embodiment, about 6% or 12% CMC-Na was used to synthesize natural binder.

Co-polymer. In some embodiments and aspects of the present invention, the hydroxyl group of CMC may be co-polymerized with suitable co-polymer via a suitable reaction mechanism. In some embodiments, CMC may be co-polymerized (i.e., grafted) with n-hydroxy methyl acrylamide. In some embodiments, CMC may be co-polymerized (i.e., grafted) with n-hydroxy methyl acrylamide via free radical polymerization.

In some embodiments, the grafted co-polymer binder may be biodegradable due to backbone molecule chain of CMC being degradable by the same or similar pathways as biodegradable cellulose. The degree of biodegradability refers to aerobic biodegradability in soil as determined in accordance with ISO 17556:2003 E.

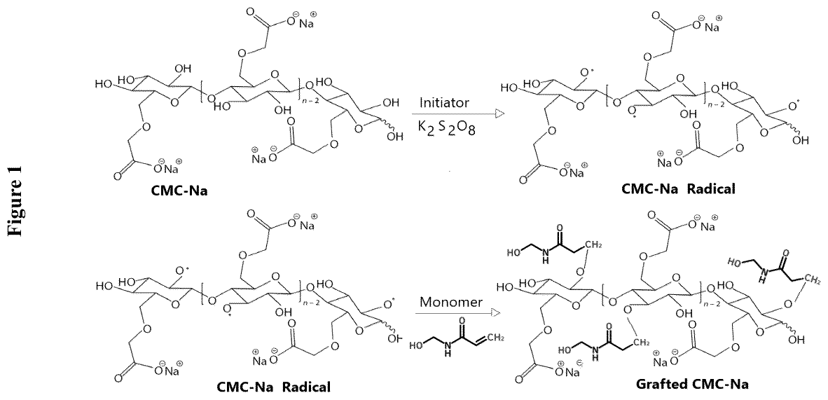

FIG. 1 illustrates a grafting polymerization reaction scheme of the present invention. CMC-Na is converted in the presence of an initiator, potassium persulfate (K₂S₂O₈), into a CMC-Na radical with several O^{•} sites, to which a monomer, such as n-hydroxy methyl acrylamide, can bind. Other suitable initiators of the present invention are discussed below.

In some aspects and embodiments of the present invention, monomer concentrations from 1-100% may be used, 10%-90%, 30%-70%, 40%-60%, 50% may be used as a percentage of monomer:CMC wt:wt in the reaction.

Initiators, catalysts. In embodiments of the present invention, potassium persulfate (K₂S₂O₈) and/or hydrogen peroxide (H₂O₂) may be used as an initiator of polymerization. In some aspects and embodiments, 0.1% to 1.0% of an initiator, such as K₂S₂O₈ may be used in the reaction, in some aspects >1.0% of an initiator, 0.3% to 0.9%, 0.3% to 0.9%, 0.5% to 0.9%, 0.7 to 1%, 0.7 to 0.9%, 0.7%, based on initiator: monomer wt:wt. In some aspects, a small amount of additional initiator (e.g., H₂O₂) may be added dropwise (e.g., about 3 drops per 200 ml, see Example 2 below) to the reaction. Other initiators known in the art may be used as well.

Reaction Time and Temperature. In some aspects the reaction time ranges from 0.1 to 3.0 hours. In some aspects, 0.5 to 2.5 hours. In some aspects, the reaction occurs at a temperature ranging from 20 to 80° C., from 50 to 80° C., from 60 to 80° C., from 70 to 80° C. In some aspects of the present invention the reaction temperature is 70° C.

Example 2. Grafted CMC-Na based Natural Binder. The overall objective was to develop a biodegradable and environment-friendly cellulose-based natural binder to increase the strength of nonwoven fabrics with similar wet-strength properties to latex binder.
CMC concentration in 200 mL H₂O: 3%
Monomer concentration S:S to CMC weight: 50%
K₂S₂O₈ weight to CMC weight: 0.7%
H₂O₂: 3 drops
Time optimization: 1.0 hour
Temperature optimization: 70° C.
   A total of 6.0 g of CMC-Na was dissolved in 150 mL of hot water in a beaker and then cooled down to maintain a temperature of 70° C. In a separate beaker, 43.75 mL water was measured, to which was added 0.042 g of potassium persulfate (K₂S₂O₈) followed by 3 drops of hydrogen peroxide (H₂O₂) and then stirred with a magnetic bar for 20 minutes at 40° C. to completely dissolved. The contents of the two beakers were combined into one beaker, and then added 6.25 mL of (48% dry wt.) aqueous n-hydroxymethyl acrylamide. The mixture solution in the beaker was continuously stirred with a magnetic bar and maintained a reaction temperature of 70° C. for 1 hour to form grafted CMC-Na-based Natural Binder.

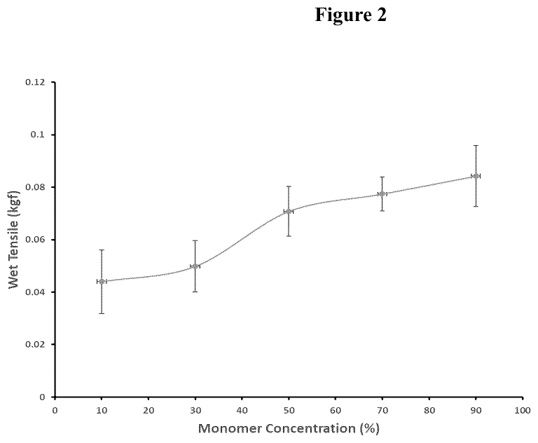

FIGS. 2-5 show aspects and embodiments of the present invention prepared with various reaction conditions. In FIGS. 2-5 all binder preparations were spray-applied at 12% concentration to a base web layer of non-woven fabric with a 55 gsm basis weight and a 0.9 mm caliper. CMC-Na salt was used, initiator concentrations (K₂S₂O₈) were 0.7%, reaction time was 1 hour, and reaction temperature 70° C., unless otherwise specified in the description for a particular figure.

FIG. 2 shows the effect on wet tensile strength (in kgf) of embodiments of the present invention with varying concentrations of monomer in aspects of the binder reaction of the present invention, such that wet strength can be controlled, in part, by the amount of monomer to CMC (e.g., wt:wt) in the polymerization reaction. In aspects of the binder reaction shown, monomer concentrations ranged from 10% to 90% wt:wt

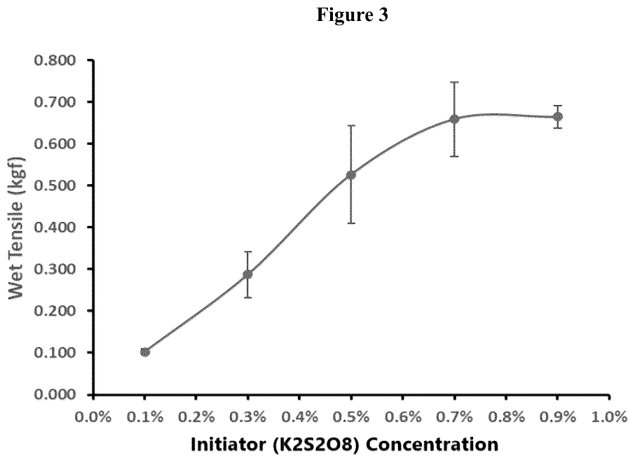

FIG. 3 shows the effect on wet tensile strength (in kgf) of embodiments of the present invention with varying concentrations of initiator (K₂S₂O₈) in aspects of the binder reaction of the present invention, such that wet strength can be controlled, in part, by the amount of initiator to CMC (e.g., wt:wt) in the polymerization reaction. In aspects of the binder reaction shown, initiator concentrations ranged from 0.1% to 0.9% wt:wt.

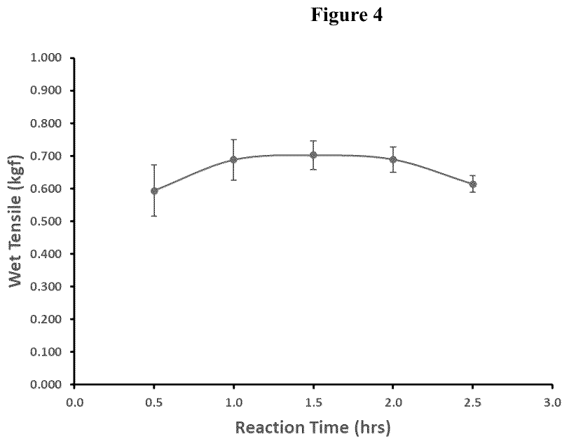

FIG. 4 shows the effect on wet tensile strength (in kgf) of embodiments of the present invention with varying reaction times in aspects of binder reaction of the present invention, such that wet strength can be controlled, in part, by the extent to which the reaction is allowed to run. In aspects of the binder reaction shown, initiator concentrations ranged from 0.5 to 2.5 hours.

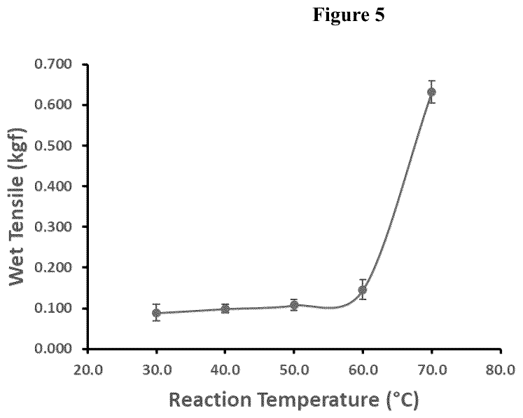

FIG. 5 shows the effect on wet tensile strength (in kgf) of embodiments of the present invention with varying reaction temperatures in aspects of binder reaction of the present invention, such that wet strength can be controlled, in part, by the temperature(s) at which the reaction is run. In aspects of the binder reaction shown, initiator concentrations ranged from 30 to 70° C.

In some embodiments and aspects of the present invention, grafted CMC can be blended with other strengthening agents depending on the application. In one example aspect and embodiment, additional poly n-hydroxymethyl acrylamide was added into grafted CMC-Na solution to increase the wet strength property of nonwoven fabric. The binder and poly n-hydroxymethyl acrylamide both lend strength as they bond with the base layer as it dries.

Example 3. Blends with Grafted CMC-Na based Natural Binder. In an example aspect and embodiment of the present invention, grafted carboxymethyl cellulose (in this example, CMC-Na was used) solution was blended with a synthesized poly n-hydroxymethyl acrylamide emulsion to add additional wet strength. For comparison purposes, grafted carboxymethyl cellulose alone, along with a commercial latex binder were also applied to a commercially available nonwoven fabric with a caliper of 0.9 mm and a basis weight of 55 gsm.

For the preparation of nonwoven fabric, about 12% of both the blended grafted CMC and grafted CMC binders (by dry wt. based on weight of fabric) was sprayed (both sides) on the surface of the pulp fiber web (55 gsm) and then dried at 160-170° C. for 5 minutes. Similarly, about 12% commercial latex binder (V-192 from Wacker) was applied on both sides of the surface of the pulp fiber web (55 gsm) and then dried at 160-170° C. for 5 minutes to produce nonwoven fabric as a control sample.

A softening agent (i.e., commercially available lotion) was added to all binders in Example 3. However, other suitable softening agents can be used in aspects and embodiments of the present invention, including those known in the art, such as lotions, boric acid, non-ionic detergent, polyethylene emulsions, polyethylene glycol, and the like.

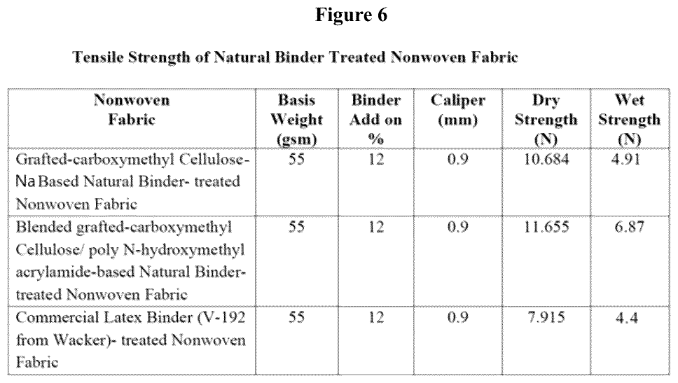

FIG. 6 provides the results of the experiment. Our test results showed that the natural binders (i.e., grafted carboxymethyl cellulose solution and blended grafted carboxymethyl cellulose) treatment to the nonwoven fabric significantly, increasing permanent wet (4.91 Newtons) and dry (10.68 Newtons) strength, which is about 11% and 26% higher than synthetic latex binder-treated nonwoven fabric, respectively.

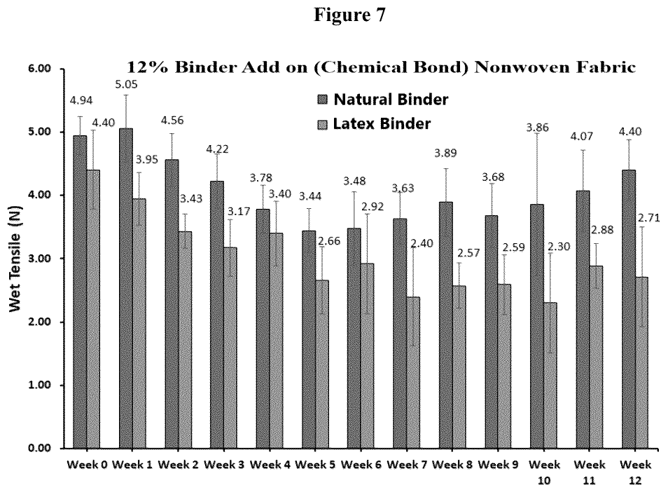

Example 4. An experiment was undertaken to study the wet strength of embodiments of the present invention over time, in simulated aging conditions in aqueous storage at 40° C. Grafted binder (i.e., “natural binder”) and latex binder were prepared with additional lotion as in Example 3 and stored in water at an incubator set at 40° C. Upon treatment and each week thereafter, wet strength was tested for 12 weeks. As seen in FIG. 7, after week 12, lotion-moisturized natural binder-treated nonwoven fabric still held a high wet strength (4.4 Newtons) compared to the latex binder-treated nonwoven fabric wet strength (2.71 Newtons).

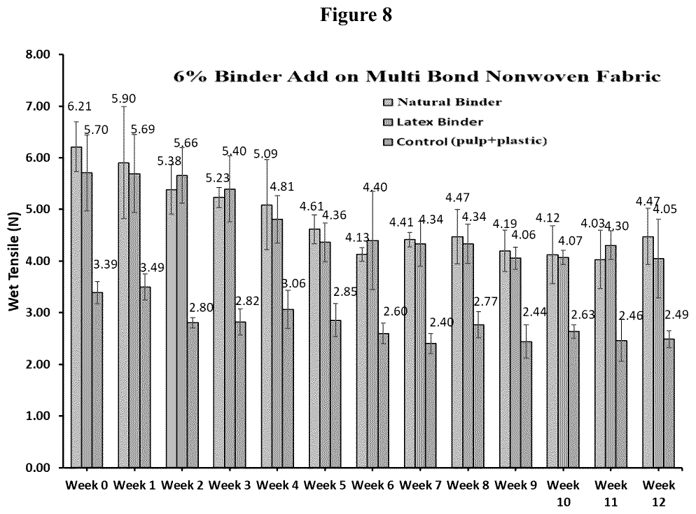

Example 5. A similar experiment as in Example 4 was conducted to evaluate embodiments of the present invention over time (12 weeks). In this example, an embodiment of the present invention, that is, a nonwoven fabric of pulp and plastic fibers prepared with 6% grafted CMC binder (dry wt. pulp fiber, plastic fiber and natural binder ratio is 74:20:6), were tested against a latex control as well as a pulp-plastic control and were maintained at 40° C. to simulate rapid aging conditions. Both fabrics were lotion-treated. As seen in FIG. 8, the grafted binder performed as well as the latex binder control in terms of maintaining wet strength over time. Thus, biodegradable natural binders of the present invention can be an alternative to nonbiodegradable petroleum-based latex binder for nonwoven and textile applications.

Other components. Embodiments of the presently disclosed grafted and blended grafter non-woven fabric can further include one or more components for personal care applications. In certain embodiments, the one or more personal care components can include preservatives, fragrances, skin protectants such as humectants and/or emollients, thickeners, sequestering agents, pH adjusters, disinfectants and combinations thereof. However, a person of skill in the art will appreciate that various other and additional components, e.g., those commonly used in the art in formulations suitable for use with fibrous substrates, can also be present.

### Methods of Manufacture.

A variety of processes can be used to apply the grafted natural binder and blends thereof to nonwoven fabrics. A method of making a nonwoven fabric of the present invention can comprise a step of contacting at least a portion of the base layer with the aqueous binder to form a binder-impregnated base layer. The fiber web can be contacted with the aqueous binder by using any suitable methodology. In an aspect, the aqueous binder can be contacted with (e.g., applied to) the base layer via a saturation bonding method, a foam bonding method, a spray bonding method, a print bonding method, and the like, or combinations thereof. Methods of formation can include but are not limited to, traditional wet laying processes and dry forming processes such as air-laying and carding, or any other suitable forming technologies such as spunlace or airlaid. In an aspect, the nonwoven fabrics can be prepared by an airlaid process.

1. A grafted aqueous carboxymethyl cellulose (CMC) binder comprising CMC chemically bonded with a monomer, wherein the CMC is characterized by a weight ratio of water to CMC of from about 99.9:0.1 to about 1,000:500, wherein the monomer is characterized by a weight ratio of monomer to CMC of from about 1:1 to about 1:1,000.

2. The grafted aqueous carboxymethyl cellulose (CMC) binder of claim 1, wherein the monomer is n-hydroxy methyl acrylamide.

3. The grafted aqueous carboxymethyl cellulose (CMC) binder of claim 1, wherein the CMC is a CMC or CMC salt, CMC alkali salt, CMC-Na.

4. The grafted aqueous carboxymethyl cellulose (CMC) binder of claim 1, wherein said binder is a sprayable aqueous solution.

5. The grafted aqueous carboxymethyl cellulose (CMC) binder of claim 1, wherein said binder comprises CMC in an amount of from about 0.1 wt. % to about 70 wt. % of the total binder content.

6. The grafted aqueous carboxymethyl cellulose (CMC) binder of claim 1, wherein said binder comprises the monomer in an amount of from about 0.1 wt. % to about 90 wt. %.

7. The grafted aqueous carboxymethyl cellulose (CMC) binder of claim 1, further comprising an initiator in an amount of from about 0.1 wt. % to about 10 wt. %.

8. The grafted aqueous carboxymethyl cellulose (CMC) binder of claim 1, wherein said initiator comprises K₂S₂O₈; or K₂S₂O₈ and H₂O₂.

9. The grafted aqueous carboxymethyl cellulose (CMC) binder of claim 1, wherein said binder is formed via a graft polymerization reaction between CMC and n-hydroxymethyl acrylamide, wherein the graft polymerization reaction temperature occurs from about 10° C. to about 200° C.

10. The grafted aqueous carboxymethyl cellulose (CMC) binder of claim 1, wherein said binder is formed via a graft polymerization reaction between CMC and n-hydroxymethyl acrylamide, wherein the polymerization reaction time is from about 0.01 minutes to about 5,000 minutes.

11. The grafted aqueous carboxymethyl cellulose (CMC) binder of claim 1, wherein said binder is biodegradable.

12. The grafted aqueous carboxymethyl cellulose (CMC) binder of claim 1, wherein said binder further comprises polymer N-hydroxymethyl acrylamide, wherein said polymer n-hydroxymethyl acrylamide is not chemically bound to said CMC bonded with a monomer.

13. (canceled)

14. (canceled)

15. (canceled)

16. (canceled)

17. (canceled)

18. A method of making a nonwoven fabric, the method comprising:
applying a portion of aqueous grafted CMC binder to a non-woven fabric base layer to form a binder-impregnated nonwoven fabric,
wherein said aqueous grafted CMC binder comprises CMC chemically bonded with a monomer, wherein the CMC is characterized by a weight ratio of water to CMC of from about 99.9:0.1 to about 1,000:500, wherein the monomer is characterized by a weight ratio of monomer to CMC of from about 1:1 to about 1:1,000.

19. The method of claim 18, wherein the dry weight ratio between grafted CMC binder and pulp fiber web is about 1.2:10.

20. The method of claim 18, wherein said applying a portion of aqueous grafted CMC binder to a non-woven fabric base layer, further comprises spraying said portion of aqueous grafted CMC binder onto said non-woven fabric base layer to form a binder-impregnated non-woven fabric.

21. The method of claim 20, further comprising curing said binder-impregnated nonwoven fabric, at 165° C. for 5 minutes.

22. A non-woven fabric, comprising a grafted aqueous carboxymethyl cellulose (CMC) binder comprising CMC chemically bonded with a monomer, wherein the CMC is characterized by a weight ratio of water to CMC of from about 99.9:0.1 to about 1,000:500, wherein the monomer is characterized by a weight ratio of monomer to CMC of from about 1:1 to about 1:1,000.

23. The non-woven fabric of claim 22, wherein said fabric comprises pulp fibers in an amount from 30 wt. % to about 99.9 wt. %, based on the total weight of the nonwoven fabric and CMC in an amount of from about 0.01 wt. % to about 30 wt. %, based on the total weight of the nonwoven fabric.

24. The non-woven fabric of claim 22, wherein the nonwoven fabric is characterized by a dry tensile strength measured about 10.68 newtons.

25. The non-woven fabric of claim 22, wherein the nonwoven fabric is characterized by a wet tensile strength measured about 4.91 newtons.

26. (canceled)

27. (canceled)
